(19) United States
(12) Patent Application Publication
(10) Pub. No.: US 2003/0081024 A1
(43) Pub. Date: May 1, 2003

(54) Printing system adapted to shift nozzle use

(76) Inventors: Joan Carles Vives, San Diego, CA (US); Antoni S. Murcia, San Diego, CA (US)

Correspondence Address: HEWLETT-PACKARD COMPANY, Intellectual Property Administration, P.O. Box 272400, Fort Collins, CO, 80527-2400, US

(21) Appl. No.: 09/999,471

(22) Filed: Oct. 31, 2001

(51) Int. Cl. B41J 2/01

(52) U.S. Cl. 347/9

(57) ABSTRACT

A printing system includes a printhead assembly and a controller associated with the printhead assembly. The printhead assembly includes at least one printhead having a plurality of nozzles, and the controller is adapted to assign dot data representing an image to the plurality of nozzles and shift the dot data by at least one nozzle after a predetermined period.

### THE FIELD OF THE INVENTION

The present invention relates generally to printing systems, and more particularly to a system and method of shifting nozzle use in a printing system.

### BACKGROUND OF THE INVENTION

A conventional inkjet printing system includes a printhead, an ink supply which supplies liquid ink to the printhead, and an electronic controller which controls the printhead. The printhead ejects ink drops through a plurality of orifices or nozzles and toward a print media, such as a sheet of paper, so as to print onto the print media. Typically, the orifices are arranged in one or more arrays such that properly sequenced ejection of ink from the orifices causes characters or other images to be printed upon the print media as the printhead and the print media are moved relative to each other.

In one arrangement, commonly referred to as a fixed or non-scanning, wide-array inkjet printing system, a plurality of individual printheads are arranged in a staggered configuration to form a printhead array which spans a nominal page width of the print media. In addition, the printheads are fixed or held stationary relative to the print media as the print media is advanced during printing. With the printhead array, a number of nozzles and, therefore, an overall number of ink drops which can be ejected per second is increased. Since the overall number of drops which can be ejected per second is increased, printing speed can be increased with the wide-array inkjet printing system. One use of the fixed, wide-array inkjet printing system is for printing on a continuous form or continuous web print media which includes a continuous roll and/or plurality of contiguous print media portions each representing, for example, individual sheets, forms, labels, etc.

Unfortunately, if the conventional fixed, wide-array inkjet printing system is used to repeatedly print the same print job, for example, multiple copies of the same type of label, the same nozzles are used during printing. Consequently, some nozzles are not operated during printing of the print job and some nozzles are repeatedly operated during printing of the print job. Nozzles that are not used, therefore, are underutilized and susceptible to drying out, and nozzles that are repeatedly used are overutilized and susceptible to a short operating life relative to other nozzles of the printhead array.

One attempt to prevent nozzles from drying out includes routine ejection of ink, commonly referred to as spitting, from the nozzles to maintain an appropriate level of pressure and fluidity of the nozzles. Spitting may occur, for example, onto the print media or into a spittoon of a service station provided to a side of the printing system. Both approaches, however, waste ink and, in addition, the approach of spitting into the spittoon reduces printing speed since the printhead array must be moved to the service station for spitting.

### SUMMARY OF THE INVENTION

One aspect of the present invention provides a printing system. The printing system includes a printhead assembly and a controller associated with the printhead assembly. The printhead assembly includes at least one printhead having a plurality of nozzles, and the controller is adapted to assign dot data representing an image to the plurality of nozzles and shift the dot data by at least one nozzle after a predetermined period.

### BRIEF DESCRIPTION OF THE DRAWINGS

FIG. 1 is a block diagram illustrating one embodiment of an inkjet printing system according to the present invention.

FIG. 2 is a schematic illustration of one embodiment of a print media according to the present invention.

FIG. 3 is a schematic illustration of one embodiment of a portion of an inkjet printhead assembly according to the present invention.

FIG. 4 is a schematic illustration of one embodiment of a portion of a printhead of the inkjet printhead assembly of FIG. 3.

FIG. 5 is a schematic illustration of one embodiment of printing a series of images on the print media of FIG. 2 with the inkjet printhead assembly of FIG. 3.

FIG. 6 is a schematic illustration of one embodiment of shifting of the inkjet printhead assembly during printing of the series of images.

FIG. 7 is a schematic illustration of one embodiment of shifting of the print media during printing of the series of images.

FIG. 8 is a flow diagram illustrating one embodiment of a method of printing according to the present invention.

FIG. 9 is a flow diagram illustrating another embodiment of a portion of the method of FIG. 8.

FIG. 10 is a flow diagram illustrating another embodiment of a portion of the method of FIG. 8.

FIG. 11 is a flow diagram illustrating a portion of another embodiment of the method of FIG. 8.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. The inkjet printing system and related components of the present invention can be positioned in a number of different orientations. As such, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

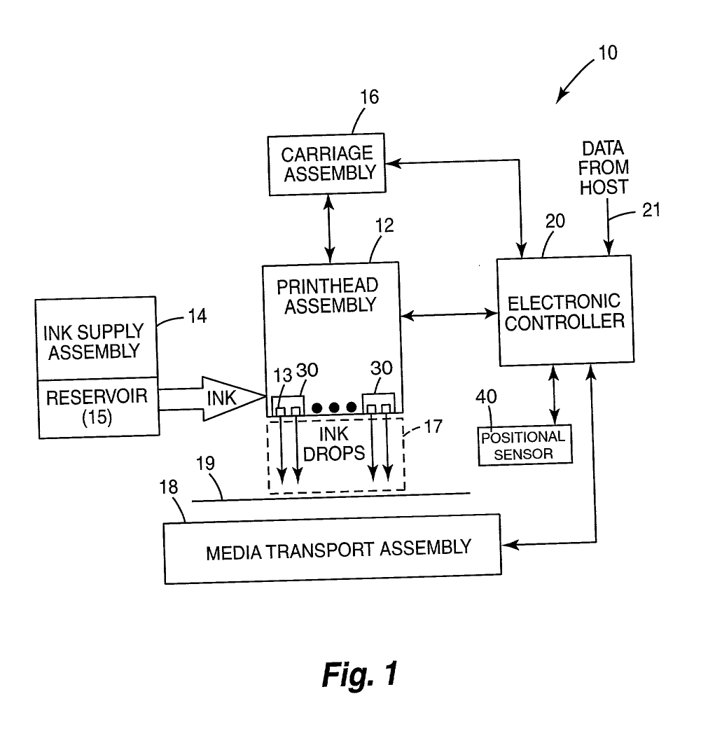

FIG. 1 illustrates one embodiment of an inkjet printing system 10 according to the present invention. Inkjet printing system 10 includes an inkjet printhead assembly 12, an ink supply assembly 14, a carriage assembly 16, a media transport assembly 18, and an electronic controller 20. Inkjet printhead assembly 12 includes one or more printheads 30 which eject drops of ink through a plurality of orifices or nozzles 13 and toward a print media 19 so as to print onto print media 19. Print media 19 is any type of suitable sheet material, such as paper, card stock, envelopes, labels, transparencies, Mylar, and the like. Typically, nozzles 13 are arranged in one or more columns or arrays such that properly sequenced ejection of ink from nozzles 13 causes characters, symbols, and/or other graphics or images to be printed upon print media 19 as inkjet printhead assembly 12 and print media 19 are moved relative to each other.

Ink supply assembly 14 supplies ink to printhead assembly 12 and includes a reservoir 15 for storing ink. As such, ink flows from reservoir 15 to inkjet printhead assembly 12. In one embodiment, inkjet printhead assembly 12 and ink supply assembly 14 are housed together in an inkjet cartridge or pen. In another embodiment, ink supply assembly 14 is separate from inkjet printhead assembly 12 and supplies ink to inkjet printhead assembly 12 through an interface connection, such as a supply tube.

Carriage assembly 16 positions inkjet printhead assembly 12 relative to media transport assembly 18 and media transport assembly 18 positions print media 19 relative to inkjet printhead assembly 12. Thus, a print zone 17 is defined adjacent to nozzles 13 in an area between inkjet printhead assembly 12 and print media 19. In one embodiment, inkjet printhead assembly 12 is a non-scanning type printhead assembly. As such, carriage assembly 16 fixes inkjet printhead assembly 12 at a prescribed position relative to, media transport assembly 18. Thus, media transport assembly 18 advances or positions print media 19 relative to inkjet printhead assembly 12.

Electronic controller 20 communicates with inkjet printhead assembly 12, media transport assembly 18, and, in one embodiment, carriage assembly 16. Electronic controller 20 receives data 21 from a host system, such as a computer, and includes memory for temporarily storing data 21. Typically, data 21 is sent to inkjet printing system 10 along an electronic, infrared, optical or other information transfer path. Data 21 represents, for example, an image, a document, and/or file to be printed. As such, data 21 forms a print job for inkjet printing system 10 and includes one or more print job commands and/or command parameters.

In one embodiment, electronic controller 20 provides control of inkjet printhead assembly 12 including timing control for ejection of ink drops from nozzles 13. As such, electronic controller 20 operates on data 21 to define a pattern of ejected ink drops which form characters, symbols, and/or other graphics or images on print media 19. Timing control and, therefore, the pattern of ejected ink drops, is determined by the print job commands and/or command parameters. In one embodiment, logic and drive circuitry forming a portion of electronic controller 20 is located on inkjet printhead assembly 12. In another embodiment, logic and drive circuitry is located off inkjet printhead assembly 12.

In one embodiment, inkjet printing system 10 includes a positional sensor 40 which senses a position of print media 19. More specifically, positional sensor 40 senses a position of print media 19 relative to inkjet printhead assembly 12 as print media 19 is advanced during printing. Positional sensor 40 includes, for example, a rotational encoder which rotates in response to advance of print media 19 and generates a corresponding signal or pulse. As such, the rotational encoder generates, for example, a predetermined number of pulses per revolution. Thus, a number of pulses of the rotational encoder can be translated or converted into a distance of advance of print media 19. Positional sensor 40 may also include a top-of-form (TOF) detector which detects a top of leading portion of print media 19 as print media 19 is advanced relative to inkjet printhead assembly 12 during printing. As such, the TOF detector detects, for example, the presence of top-of-form (TOF) marks on print media 19.

Positional sensor 40 communicates a position of print media 19 with controller 20. In one embodiment, positional sensor 40 is associated with media transport assembly 18 and fixed relative to inkjet printhead assembly 12. Positional sensor 40, for example, may be associated with a roller or other component of media transport assembly 18 which rotates or moves as print media 19 advances or moves through inkjet printing system 10.

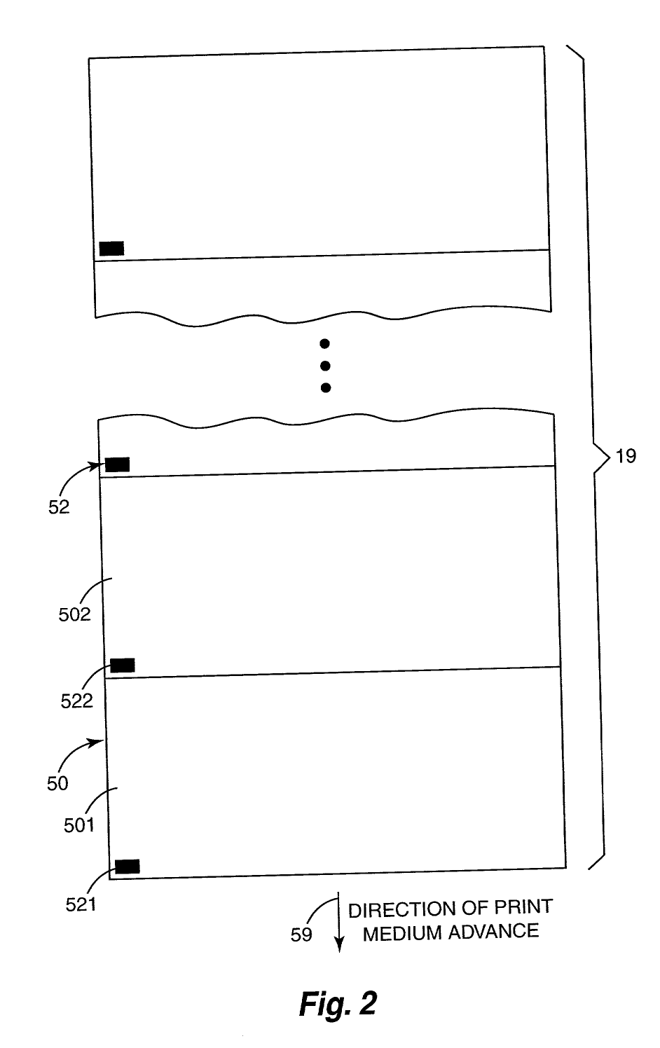

In one embodiment, as illustrated in FIG. 2, print media 19 is a continuous form or continuous web print media 19. As such, print media 19 includes a plurality of contiguous print media portions 50. Print media portions 50 represent, for example, individual sheets, forms, labels, or the like which may be physically separated from each other by cutting or by tearing along, for example, perforated lines. In addition, print media 19 may include a continuous roll of unprinted paper with print media portions 50 being delineated by indicia, openings, or other markings. Since inkjet printhead assembly 12 is fixed, print media 19 moves relative to inkjet printhead assembly 12 during printing. More specifically, print media 19 is advanced relative to inkjet printhead assembly 12 in a direction indicated by arrow 59.

In one embodiment, each print media portion 50 of print media 19 has an indicator 52 which identifies a top or leading portion of the respective print media portion 50. As such, indicator 52 is referred to hereinafter as a top-of-form (TOF) indicator. The top or leading portion of each print media portion 50 includes that portion or edge of each print media portion 50 in the direction of arrow 59. In one embodiment, print media 19 includes, for example, a first print media portion 501 and a second print media portion 502 contiguous with first print media portion 501. As such, first print media portion 501 has a first TOF indicator 521 and second print media portion 502 has a second TOF indicator 522. It is understood that print media 19 may include any number of print media portions 50 each having a respective TOF indicator 52 and that TOF indicators 52 are spaced a fixed distance relative to each other.

TOF indicator 52 of each print media portion 50 includes, for example, any indicia, opening, or other marking, reference, or registration associated with a respective print media portion 50. As such, positional sensor 40 of inkjet printing system 10 is designed accordingly so as to read or sense TOF indicator 52 of print media portions 50. If, for example, TOF indicator 52 includes indicia, positional sensor 40 may include an optical sensor which visually senses TOF indicator 52. If, for example, TOF indicator 52 includes an opening, positional sensor 40 may include a probe which physically senses TOF indicator 52.

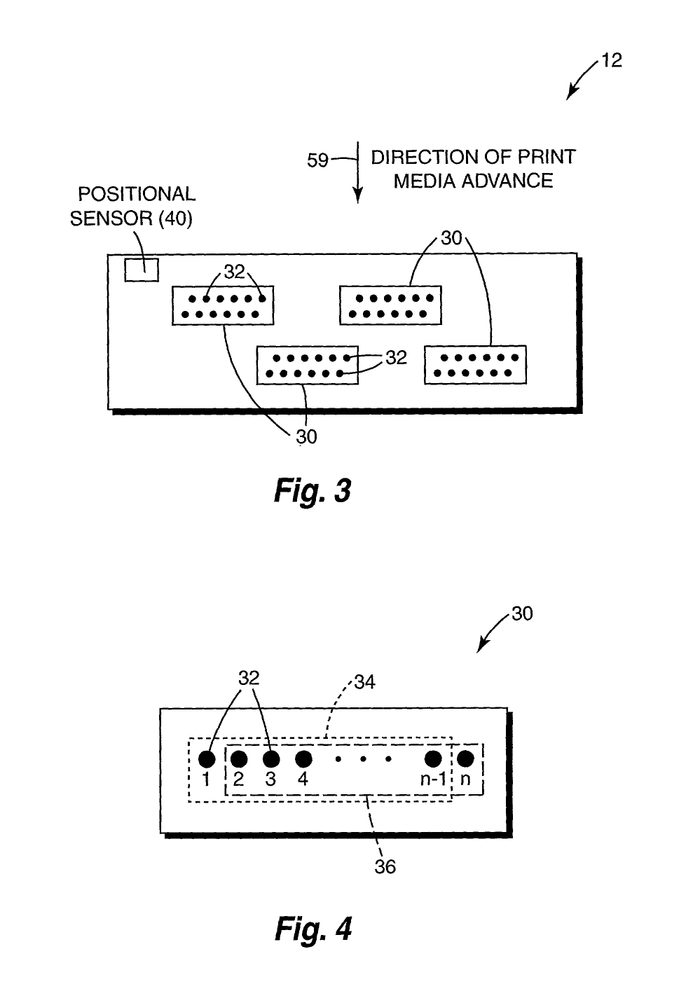

FIG. 3 illustrates one embodiment of a portion of inkjet printhead assembly 12. Inkjet printhead assembly 12 is a fixed or non-scanning, wide-array or multi-head printhead assembly and includes an array or plurality of inkjet printheads 30. In one embodiment, printheads 30, also referred to as printhead dies, are spaced apart and staggered such that each printhead 30 is aligned with and/or overlaps at least one adjacent printhead 30. As such, inkjet printhead assembly 12 may span a nominal page width or a width shorter than or longer than a nominal page width. In one embodiment, printheads 30 are arranged in a staggered, offset manner. While inkjet printhead assembly 12 is illustrated as including four printheads, the number of printheads may vary.

As illustrated in FIGS. 3 and 4, each printhead 30 includes an array of printing or drop-ejecting elements or nozzles 32, as is known in the art. For clarity of the invention, the following description only refers to one column of nozzles 32, as illustrated in FIG. 4. It is understood, however, that concepts of the present invention are also applicable to printheads having multiple columns of nozzles 32 as illustrated, for example, in FIG. 3.

Example embodiments of printheads 30 include a thermal printhead, a piezoelectric printhead, a flex-tensional printhead, or any other type of inkjet ejection device known in the art. In one embodiment, printheads 30 are fully integrated thermal inkjet printheads. As such, each drop-ejecting element or nozzle 32 includes a nozzle opening associated with a nozzle chamber such that droplets of ink fed to the nozzle chamber are ejected through the nozzle opening and toward a print media upon energization of a firing resistor positioned within the nozzle chamber.

As illustrated in FIG. 4, each printhead 30 includes at least one column of nozzles 32. Nozzles 32 are numbered, for example, 1, 2, 3, 4, . . . n−1, n. Data 21 (FIG. 1) representing, for example, an image, such as characters, symbols, and/or other graphics, to be printed on print media 19 is mapped or assigned by electronic controller 20 to selective nozzles 32 as dot data. The dot data indicates a desired location of dots on print media 19 to form the image to be printed. As such, the dot data is used to control operation of nozzles 32 of printhead 30 to print on print media 19.

In one embodiment, nozzles 32 are logically divided into a first set 34 of nozzles 32 and a second set 36 of nozzles 32. First set 34 of nozzles 32 is referred to, hereinafter, as first nozzle set 34 and second set 36 of nozzles 32 is referred to, hereinafter, as second nozzle set 36. First nozzle set 34 includes, for example, nozzles numbered 1 through n−1 and second nozzle set 36 includes, for example, nozzles numbered 2 through n. Thus, second nozzle set 36 is offset from first nozzle set 34 by at least one nozzle 32. It is understood, however, that second nozzle set 36 may be offset from first nozzle set 34 by any number of nozzles 32 and that first nozzle set 34 and/or second nozzle set 36 may include nozzles 32 numbered different than those described above.

Electronic controller 20 assigns dot data to first nozzle set 34 such that selective nozzles 32 of first nozzle set 34 are operated to print dots on print media 19 and print an image. Thereafter, as described below, electronic controller 20 shifts and reassigns the dot data to second nozzle set 36 such that selective nozzles 32 of second nozzle set 36 are operated to print dots on print media 19 and print another image, including, for example, another copy of the image. In one embodiment, second nozzle set 36 includes at least one nozzle 32 included in first nozzle set 34. When inkjet printhead assembly 12 includes multiple printheads 30, it is understood that each printhead 30 includes a respective first nozzle set 34 and a respective second nozzle set 36.

Preferably, electronic controller 20 shifts the dot data and selectively operates first nozzle set 34 and second nozzle set 36 so as to provide substantially uniform use of nozzles 32. For example, in one embodiment, second nozzle set 36 includes at least one nozzle which has been excluded from first nozzle set 34. In one embodiment, second nozzle set 36 includes at least one nozzle which has not been operated within a predetermined period. In one embodiment, second nozzle set 36 includes at least one nozzle which has been operated less than a predetermined number of times within a predetermined period. Thus, by including in second nozzle set 36 at least one nozzle which has been excluded from first nozzle set 34, at least one nozzle which has not been operated within a predetermined period, and/or at least one nozzle which has been operated less than a predetermined number of times within a predetermined period, electronic controller 20 provides for use of such nozzles by including such nozzles in second nozzle set 36. In another embodiment, second nozzle set 36 excludes at least one nozzle which has been operated greater than a predetermined number of times within a predetermined period. Thus, by excluding from second nozzle set 36 at least one nozzle which has been operated greater than a predetermined number of times within a predetermined period, electronic controller 20 avoids additional use of such nozzle by excluding such nozzle from second nozzle set 36.

In one embodiment, the predetermined period during which operation of nozzles 32 is measured or monitored includes, for example, a predetermined time and/or printing of a predetermined number of copies of an image. As such, operation of first nozzle set 34 and/or second nozzle set 36 may be selected based on expiration of the predetermined time and/or printing of the predetermined number of copies of the image.

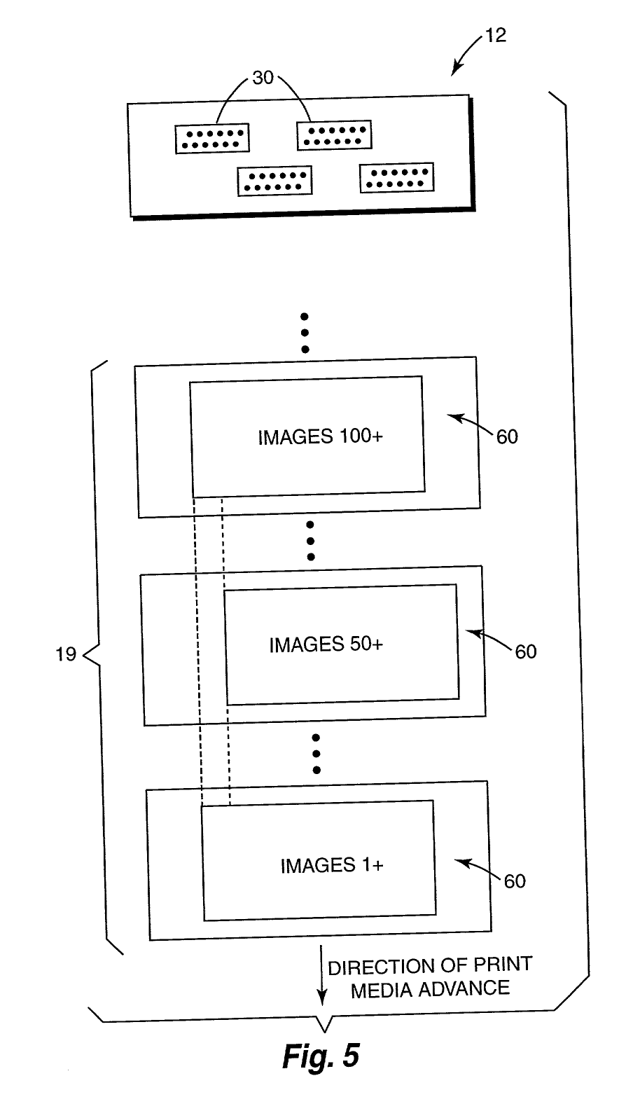

In one embodiment, as illustrated in FIG. 5, electronic controller 20 selectively operates first nozzle set 34 and second nozzle set 36 based on printing of a predetermined number of copies of an image 60 on print media 19. When electronic controller 20 receives a print job including multiple copies, electronic controller 20, as the printer/device driver, divides the print job into different groups of predetermined numbers of copies to be printed by different nozzle sets. For example, electronic controller 20 divides a print job of several hundred copies of image 60 into groups of 50 copies such that first nozzle set 34 is operated to print a first group of 50 copies of image 60, second nozzle set 36 is operated to print a second group of 50 copies of image 60, first nozzle set 34 is operated to print a third group of 50 copies of image 60, and so on. Thus, electronic controller 20 divides the print job into different groups so as to provide substantially uniform use of nozzles 32 during printing of the print job. Accordingly, with a print job including multiple copies, the print job is redefined by electronic controller 20 to offset the dot data of the print job by at least one nozzle each predefined number of copies.

Image 60 includes characters, symbols, and/or other graphics printed on print media 19. Image 60 is defined to include the same image and/or different images within a group of copies of image 60. In addition, image 60 printed by first nozzle set 34 and image 60 printed by second nozzle set 36 may be the same image and/or different images. Furthermore, image 60 may be printed as the same print job (e.g., multiple copies of the same label) and/or the same type of print job (e.g., multiple copies of the same label layout).

In one embodiment, with a printhead designed to print a 600 dots-per-inch (DPI) print swath, a two-column array, as illustrated in FIG. 3, has nozzles 32 spaced at 1/300th of an inch in each column and staggered a half space, namely 1/600th of an inch, relative to each other. As such, offsetting of second nozzle set 36 from first nozzle set 34 by, for example, one nozzle is unnoticeable between image 60 printed by first nozzle set 34 and image 60 printed by second nozzle set 36 under normal viewing conditions.

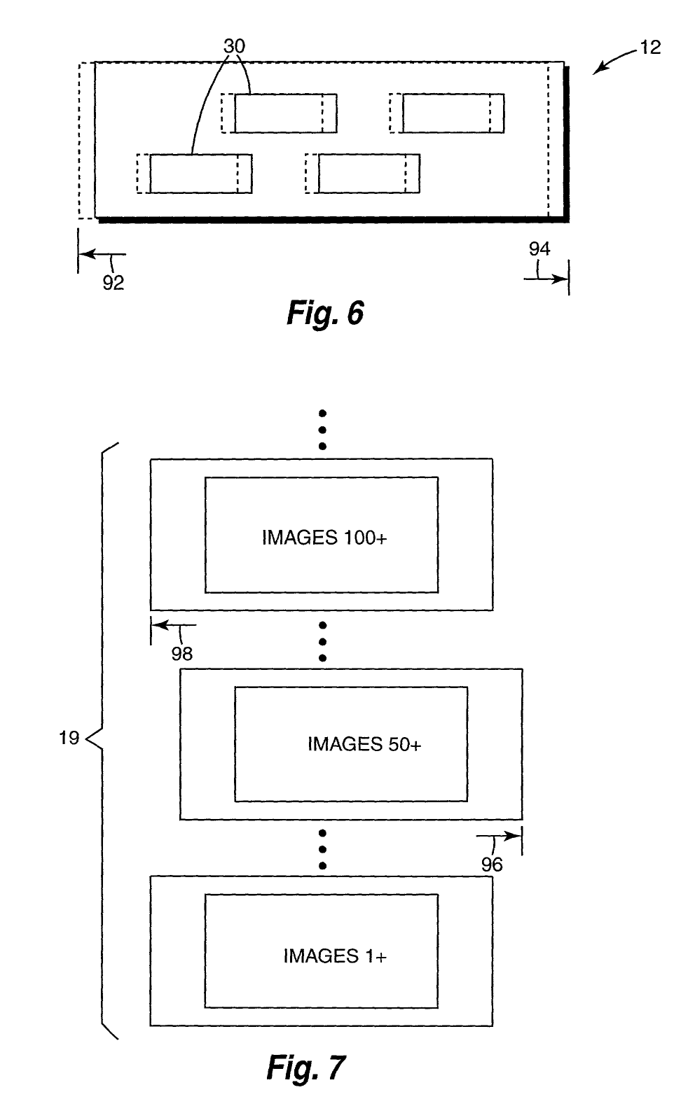

In one embodiment, as illustrated in FIG. 6, electronic controller 20 is adapted to shift inkjet printhead assembly 12 based on operation of first nozzle set 34 and second nozzle set 36. For example, when electronic controller 20 shifts operation from first nozzle set 34 to second nozzle set 36, the dot data is shifted in one direction (e.g., to the right). As such, inkjet printhead assembly 12 is shifted in an opposite direction (e.g., to the left, as indicated by arrow 92) to compensate for shifting of the dot data. Furthermore, when electronic controller 20 shifts operation from second nozzle set 36 to first nozzle set 34, the dot data is shifted in one direction (e.g., to the left). As such, inkjet printhead assembly 12 is shifted in an opposite direction (e.g., to the right, as indicated by arrow 94) to compensate for shifting of the dot data.

Printhead assembly 12 is shifted, for example, via carriage assembly 16 (FIG. 1). Preferably, inkjet printhead assembly 12 is shifted a distance corresponding to the offset between nozzles of first nozzle set 34 and second nozzle set 36. As such, image 60 is printed in the same relative position on print media 19 regardless of whether first nozzle set 34 or second nozzle set 36 prints image 60.

In one embodiment, as illustrated in FIG. 7, electronic controller 20 is adapted to shift print media 19 based on operation of first nozzle set 34 and second nozzle set 36. For example, when electronic controller 20 shifts operation from first nozzle set 34 to second nozzle set 36, the dot data is shifted in one direction (e.g., to the right). As such, print media 19 is shifted in the same direction (e.g., to the right, as indicated by arrow 96) to compensate for shifting of the dot data. Furthermore, when electronic controller 20 shifts operation from second nozzle set 36 to first nozzle set 34, the dot data is shifted in one direction (e.g., to the left). As such, print media 19 is shifted in the same direction (e.g., to the left, as indicated by arrow 98) to compensate for shifting of the dot data.

Print media 19 is shifted, for example, via media transport assembly 18 (FIG. 1). Preferably, print media 19 is shifted a distance corresponding to the offset between nozzles of first nozzle set 34 and second nozzle set 36. Thus, image 60 is printed in the same relative position on print media 19 regardless of whether first nozzle set 34 or second nozzle set 36 prints image 60.

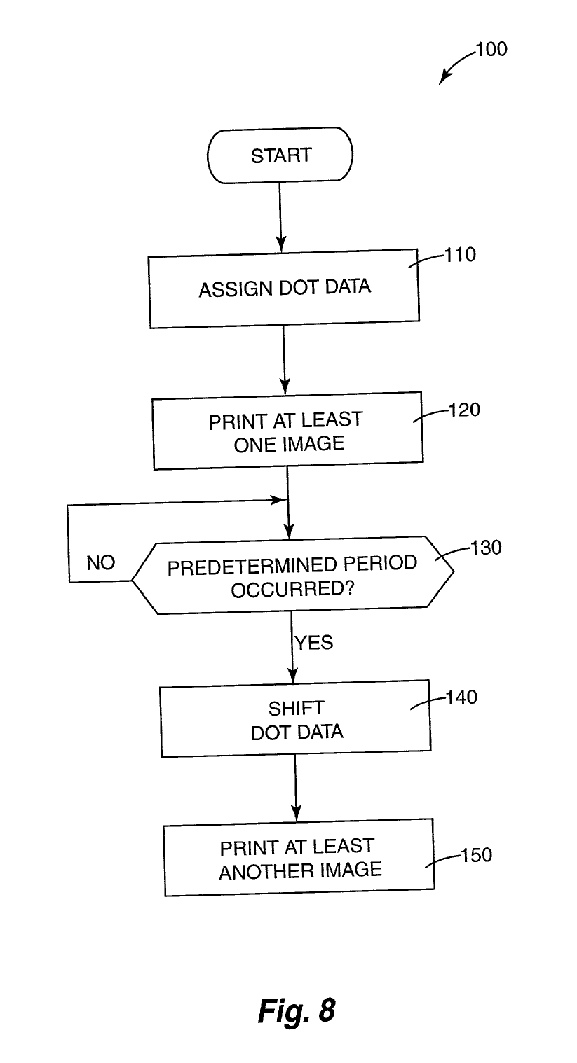

FIG. 8 illustrates one embodiment of a method 100 of printing with inkjet printing system 10. Reference is also made to FIGS. 1-7. At step 110, dot data indicating a location of dots on print media 19 to form image 60 is assigned to nozzles 32. More specifically, dot data is assigned, for example, to first nozzle set 34 by electronic controller 20, as described above.

At step 120, at least one image 60 is printed by inkjet printhead assembly 12. With dot data assigned to first nozzle set 34, first nozzle set 34 prints at least one image 60, including at least one copy of image 60, on print media 19. It is understood that any number of copies of image 60 may be printed on print media 19 at step 120.

At step 130, whether a predetermined period during printing with inkjet printhead assembly 12 has occurred is assessed. In one embodiment, for example, whether a predetermined time has elapsed during printing of image 60 has occurred is assessed. In another embodiment, for example, whether printing of a predetermined number of copies of image 60 has occurred is assessed. Preferably, whether the predetermined period has occurred is assessed in step 130 after printing of at least one copy of image 60 in step 120. If the predetermined period has not occurred, method 100 returns. If, however, the predetermined period has occurred, method 100 proceeds to step 140.

At step 140, after the predetermined period has occurred, as assessed in step 130, dot data indicating a location of dots on print media 19 to form image 60 is shifted among nozzles 32. More specifically, dot data is shifted, for example, from first nozzle set 34 to second nozzle set 36 by electronic controller 20, as described above. In one embodiment, shifting of the dot data to second nozzle set 36 includes, for example, shifting of the dot data to include in second nozzle set 36 at least one nozzle which has been excluded from first nozzle set 34, at least one nozzle which has not been operated within a predetermined period, and/or at least one nozzle which has been operated less than a predetermined number of times within a predetermined period. In another embodiment, shifting of the dot data to second nozzle set 36 includes, for example, shifting of the dot data to exclude from second nozzle set 36 at least one nozzle which has been operated greater than a predetermined number of times within a predetermined period.

At step 150, after shifting of the dot data in step 140, at least another image 60 is printed by inkjet printhead assembly 12. More specifically, with dot data assigned to second nozzle set 36, second nozzle set 36 prints at least another image 60, including at least another copy of image 60, on print media 19. It is understood that any number of copies of image 60 may be printed on print media 19 at step 150.

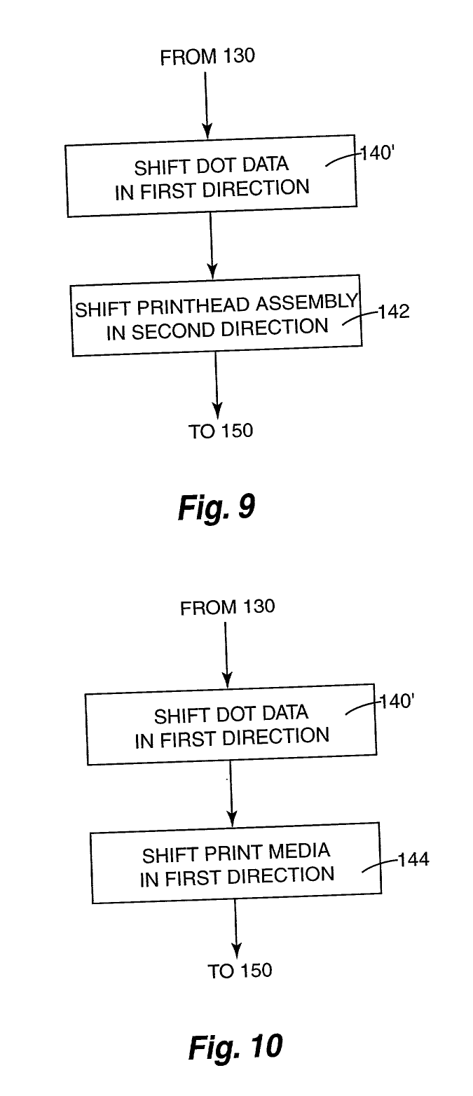

FIG. 9 illustrates another embodiment of a portion of method 100. More specifically, after the predetermined period has occurred, as assessed in step 130, dot data indicating a location of dots on print media 19 to form image 60 is shifted among nozzles 32 in step 140′. More specifically, dot data is shifted, for example, from first nozzle set 34 to second nozzle set 36 in a first direction by electronic controller 20, as described above. Thus, at step 142, printhead assembly 12 is shifted in a second direction opposite the first direction to compensate for the shift of the dot data in the first direction, as illustrated and described above, for example, with reference to FIG. 6. Preferably, inkjet printhead assembly 12 is shifted a distance substantially equal to the offset between nozzles of first nozzle set 34 and second nozzle set 36.

FIG. 10 illustrates another embodiment of a portion of method 100. More specifically, after the predetermined period has occurred, as assessed in step 130, dot data indicating a location of dots on print media 19 to form image 60 is shifted among nozzles 32 at step 140′ in a first direction, as described above. Thus, at step 144, print media 19 is also shifted in the first direction to compensate for the shift of the dot data in the first direction, as illustrated and described above, for example, with reference to FIG. 7. Preferably, print media 19 is shifted a distance substantially equal to the offset between nozzles of first nozzle set 34 and second nozzle set 36.

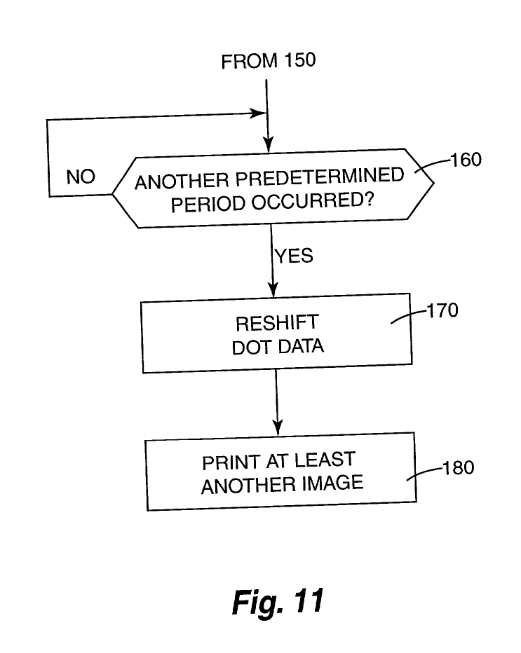

FIG. 11 illustrates another embodiment of a portion of method 100. More specifically, after printing of at least another image 60 in step 150, whether another predetermined period during printing with inkjet printhead assembly 12 has occurred is assessed at step 160. In one embodiment, for example, whether a predetermined time has elapsed during additional printing of image 60 has occurred is assessed. In another embodiment, for example, whether printing of another predetermined number of copies of image 60 has occurred is assessed. If another predetermined period has not occurred, method 100 returns. If, however, another predetermined period has occurred, method 100 proceeds to step 170.

At step 170, after another predetermined period has occurred, as assessed in step 160, dot data indicating a location of dots on print media 19 to form image 60 is reshifted among nozzles 32. More specifically, dot data is shifted, for example, from second nozzle set 36 to first nozzle set 34 by electronic controller 20, as described above. In one embodiment, shifting of the dot data to first nozzle set 34 includes, for example, shifting of the dot data to include in first nozzle set 34 at least one nozzle which has been excluded from second nozzle set 36, at least one nozzle which has not been operated within a predetermined period, and/or at least one nozzle which has been operated less than a predetermined number of times within a predetermined period. In another embodiment, shifting of the dot data to first nozzle set 34 includes, for example, shifting of the dot data to exclude from first nozzle set 34 at least one nozzle which has been operated greater than a predetermined number of times within a predetermined period.

At step 180, after shifting of the dot data in step 170, at least another image 60 is printed by inkjet printhead assembly 12. More specifically, with dot data reassigned to first nozzle set 34, first nozzle set 34 prints at least another image 60, including at least another copy of image 60, on print media 19. It is understood that any number of copies of image 60 may be printed on print media 19 at step 180.

By shifting the dot data and reassigning the dot data to include at least one nozzle which has been excluded, at least one nozzle which has not been operated within a predetermined period, and/or at least one nozzle which has been operated less than a predetermined number of times within a predetermined period, inkjet printing system 10 provides for use of such nozzles by including such nozzles within the reassignment of the dot data. In addition, by shifting the dot data and reassigning the dot data to exclude at least one nozzle which has been operated greater than a predetermined number of times within a predetermined period, inkjet printing system 10 avoids additional use of such nozzle by excluding such nozzle from the reassignment of the dot data. Inkjet printing system 10, therefore, provides substantially uniform use of nozzles 32 of printheads 30 during printing. More specifically, nozzles that are not used or underutilized are used so as to prevent the nozzles from drying out and nozzles that are repeatedly used or overutilized are excluded from use so as to lengthen an operating life of such nozzles.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A printing system, comprising:
a printhead assembly including at least one printhead; and
a controller associated with the printhead assembly,
wherein the at least one printhead includes a plurality of nozzles, and
wherein the controller is adapted to operate a first set of the nozzles to print at least one copy of an image and operate a second set of the nozzles to print at least another copy of the image.

2. The printing system of claim 1, wherein the controller is adapted to operate the first set of the nozzles and the second set of the nozzles to provide substantially uniform use of the plurality of nozzles.

3. The printing system of claim 1, wherein the second set of the nozzles is offset from the first set of the nozzles by at least one nozzle.

4. The printing system of claim 1, wherein the second set of the nozzles includes at least one nozzle excluded from the first set of the nozzles.

5. The printing system of claim 4, wherein the second set of the nozzles further includes at least one nozzle included in the first set of the nozzles.

6. The printing system of claim 1, wherein the second set of the nozzles includes at least one nozzle which has not been operated within a predetermined period.

7. The printing system of claim 1, wherein the second set of the nozzles includes at least one nozzle which has been operated less than a predetermined number of times within a predetermined period.

8. The printing system of claim 1, wherein the second set of the nozzles excludes at least one nozzle which has been operated greater than a predetermined number of times within a predetermined period.

9. The printing system of claim 1, wherein the controller is adapted to operate the first set of the nozzles to print the at least one copy of the image on a print media portion and operate the second set of the nozzles to print the at least another copy of the image on another print media portion.

10. The printing system of claim 1, wherein the controller is adapted to operate the first set of the nozzles to print a first predetermined number of copies of the image and operate the second set of the nozzles to print a second predetermined number of copies of the image.

11. The printing system of claim 1, wherein the printhead assembly is a non-scanning printhead assembly.

12. A printing system, comprising:
a printhead assembly including at least one printhead; and
a controller associated with the printhead assembly,
wherein the at least one printhead includes a plurality of nozzles,
wherein the controller is adapted to assign dot data representing an image to the plurality of nozzles, and wherein the controller is adapted to shift the dot data by at least one nozzle after a predetermined period.

13. The printing system of claim 12, wherein the controller is adapted to shift the dot data to provide substantially uniform use of the nozzles.

14. The printing system of claim 12, wherein the controller is adapted to assign the dot data to a first set of the nozzles and shift the dot data from the first set of the nozzles to a second set of the nozzles after the predetermined period.

15. The printing system of claim 12, wherein the predetermined period includes a predetermined time.

16. The printing system of claim 12, wherein the predetermined period includes printing of a predetermined number of copies of the image.

17. The printing system of claim 12, wherein the controller is adapted to shift the dot data in a first direction after the predetermined period.

18. The printing system of claim 17, wherein the controller is adapted to shift the printhead assembly in a second direction opposite the first direction after the predetermined period.

19. The printing system of claim 17, wherein the inkjet printing system is adapted to print the image on print media, and wherein the controller is adapted to shift the print media in the first direction after the predetermined period.

20. The printing system of claim 12, wherein the printhead assembly is a non-scanning printhead assembly.

21. A method of printing with a printhead assembly including at least one printhead having a plurality of nozzles, the method comprising:
assigning dot data representing an image to the plurality of nozzles;
printing the image based on the dot data; and
shifting the dot data by at least one nozzle after a predetermined period.

22. The method of claim 21, wherein shifting the dot data includes shifting the dot data to provide substantially uniform use of the plurality of nozzles.

23. The method of claim 21, wherein assigning the dot data includes assigning the dot data to a first set of the nozzles, and wherein shifting the dot data includes shifting the dot data from the first set of the nozzles to a second set of the nozzles after the predetermined period.

24. The method of claim 21, wherein the predetermined period includes a predetermined time.

25. The method of claim 21, wherein the predetermined period includes printing of a predetermined number of copies of the image.

26. The method of claim 21, wherein shifting the dot data includes shifting the dot data in a first direction after the predetermined period.

27. The method of claim 26, further comprising:
shifting the printhead assembly in a second direction opposite the first direction after the predetermined period.

28. The method of claim 26, wherein printing the image includes printing the image on print media, and further comprising:
shifting the print media in the first direction after the predetermined period.

29. The method of claim 21, wherein shifting the dot data includes shifting the dot data to include at least one nozzle which has not been operated within the predetermined period.

30. The method of claim 21, wherein shifting the dot data includes shifting the dot data to include at least one nozzle which has been operated less than a predetermined number of times within the predetermined period.

31. The method of claim 21, wherein shifting the dot data includes shifting the dot data to exclude at least one nozzle which has been operated greater than a predetermined number of times within the predetermined period.

32. The method of claim 21, wherein printing the image includes printing at least one copy of the image based on the dot data, and further comprising:
printing at least another copy of the image based on the shifted dot data.

33. The method of claim 32, further comprising:
reshifting the dot data by at least one nozzle after another predetermined period; and
printing at least another copy of the image based on the reshifted dot data.
